(19) United States
(12) Patent Application Publication
(10) Pub. No.: US 2021/0024795 A1
(43) Pub. Date: Jan. 28, 2021

(54) TWO-COMPONENT POLYURETHANE ADHESIVE COMPOSITIONS

(71) Applicant: DDP SPECIALTY ELECTRONIC MATERIALS US, INC., COLLEGEVILLE, PA (US)

(72) Inventors: STEFAN SCHMATLOCH, Freienbach (CH); ILONA CADERAS, Freienbach (CH)

(21) Appl. No.: 16/980,123

(22) PCT Filed: Mar. 27, 2019
(86) PCT No.: PCT/US19/24225

§ 371 Date: Sep. 11, 2020

Related U.S. Application Data
(60) Provisional application No. 62/651,286, filed on Apr. 2, 2018.

(51) Int. Cl. C09J 175/08; B32B 7/12; B32B 37/12

(52) U.S. Cl. CPC C09J 175/08; B32B 2037/1269; B32B 37/12; B32B 7/12

(57) ABSTRACT

Disclosed are two-component polyurethane adhesive composition which include (a) an isocyanate component comprising a prepolymer which is a reaction product of one or more isocyanate compounds comprising a polyisocyanate and one or more isocyanate-reactive components comprising one or more hydrophobic polyols selected from the group consisting of poly(butylene oxide)polyol, a polybutadiene polyol, an acrylic polyol and mixtures thereof, wherein the one or more hydrophobic polyols have a functionality from 1.6 to 3.5 and a number average molecular weight from 500 g/mol to 10,000 g/mol; and (b) one or more polyol chain extenders; wherein the two-component polyurethane adhesive composition has a hydrophobic content of at least 10 wt. %.

### FIELD

The present invention relates to two-component polyurethane adhesive compositions and a process for bonding polypropylene.

### BACKGROUND

The use of composites in modern vehicles design is growing due to performance advantages and light weight vehicle requirements. Adhesive joints are the desired assembly technology for composites, as they retain the integrity of the composite structure. Additionally, the bond lines realized with adhesive bonding technologies increase the performance of bonded parts and modules with respect to stiffness and crash performance. For example, fast adhesive application reduces tact times and accelerates the assembly process. The use of polypropylene composites for the design of tail gates, lift gates or door modules represents a significant opportunity for weight as well as cost reduction. However, low energy surface substrates such as polypropylene are difficult to be bonded and physical pre-treatments (e.g., flame, plasma, and corona) as well as chemical pre-treatments (e.g., solvent based adhesion promoters) are generally used to promote adhesion.

The use of solvent based, isocyanate containing primer and activators significantly increases bonding performance. However, a reduction in the process steps and the use of solvents in the manufacturing lines are desired. Therefore, adhesive technologies that can bond to physically pre-treated polypropylene surfaces without further wet-chemical activation would be a significant advantage.

Thus, it is desired to provide an improved two-component polyurethane adhesive composition and a process for bonding polypropylene.

### SUMMARY

In one illustrative embodiment, a two-component polyurethane adhesive composition is provided which comprises:

(a) an isocyanate component comprising a prepolymer which is a reaction product of one or more isocyanate compounds comprising a polyisocyanate and one or more isocyanate-reactive components comprising one or more hydrophobic polyols selected from the group consisting of a poly(butylene oxide)polyol, a polybutadiene polyol, an acrylic polyol and mixtures thereof, wherein the one or more hydrophobic polyols have a functionality from 1.6 to 3.5 and a number average molecular weight from 500 g/mol to 10,000 g/mol; and

(b) one or more polyol chain extenders;

wherein the two-component polyurethane adhesive composition has a hydrophobic content of at least 10 wt. %.

In one illustrative embodiment, a method for bonding two substrates is provided, which comprises:

(a) applying a two-component polyurethane adhesive composition to at least a portion of a first substrate, wherein the two-component polyurethane adhesive composition comprises: (i) an isocyanate component comprising a prepolymer which is a reaction product of one or more isocyanate compounds comprising a polyisocyanate and one or more isocyanate-reactive components comprising one or more hydrophobic polyols selected from the group consisting of a poly(butylene oxide)polyol, a polybutadiene polyol, an acrylic polyol and mixtures thereof, wherein the hydrophobic polyol has a functionality from 1.6 to 3.5 and a number average molecular weight from 500 g/mol to 10,000 g/mol; and (ii) one or more polyol chain extenders;

wherein the two-component polyurethane adhesive composition has a hydrophobic content of at least 10 wt. %;

(b) contacting a second substrate with the first substrate; and

(c) curing the two-component polyurethane adhesive composition to form an adhesive bond between the first and second substrates.

The two-component polyurethane adhesive composition of the present invention advantageously exhibits improved room temperature cure resulting in high 1 hour and 2 hour lap shear strengths as well as the open times monitored by a prolonged viscosity onset. In addition, the two-component polyurethane adhesive composition allows for the substrates to be adhered together without a further wet-chemical activation step thereby avoiding the use of any solvent based treatment.

### DETAILED DESCRIPTION

Disclosed is a two-component polyurethane adhesive composition which comprises: (a) an isocyanate component comprising a prepolymer which is a reaction product of one or more isocyanate compounds comprising a polyisocyanate and one or more isocyanate-reactive components comprising one or more hydrophobic polyols selected from the group consisting of poly(butylene oxide)polyol, a polybutadiene polyol, an acrylic polyol and mixtures thereof, wherein the hydrophobic polyol has a functionality from 1.6 to 3.5 and a number average molecular weight from 500 g/mol to 10,000 g/mol; and (b) one or more polyol chain extenders; wherein the two-component polyurethane adhesive composition has a hydrophobic content of at least 10 wt. %. In one embodiment, the two-component polyurethane adhesive composition can have a hydrophobic content of at least 20 wt. %. In one embodiment, the two-component polyurethane adhesive composition can have a hydrophobic content of from 10 wt. % to 40 wt. %. The term “one or more” as used herein shall be understood to mean that at least one, or more than one, of the recited components may be used.

The isocyanate component (a) of the two-component polyurethane adhesive composition according to the present invention includes a prepolymer which is a reaction product of one or more isocyanate compounds comprising a polyisocyanate and one or more isocyanate-reactive components. In general, the isocyanate component contains 40 wt. % to 92 wt. % prepolymer, or from 50 wt. % to 85 wt. % prepolymer or from 60 wt. % to 80 wt. % prepolymer. A prepolymer may have a free isocyanate group (NCO) content of 1 wt. % to 20 wt. %, or from 2 wt. % to 10 wt. %, or from 2 wt. % to 8 wt. %, or from 2 wt. % to 6 wt. %, based on the total weight of the prepolymer. The isocyanate content in the prepolymers may be 0.5 wt. % or greater or 1 wt. % or greater, or 6 wt. % or greater, or 8 wt. % or greater or 10 wt. % or greater. The isocyanate content in the isocyanate functional prepolymers may be 35 wt. % or less, or 30 wt. % or less, or 25 wt. % or less or 15 wt. % or less. Isocyanate content as used herein means the weight percent of isocyanate groups in the designated component, such as prepolymer. The isocyanate content can be measured by analytical techniques known to one skilled in the art, for example by potentiometric titration with an active hydrogen containing compound, such as dibutyl amine. Typically, the residual content of a component can be calculated from the ingredients utilized to prepare the component or composition. Alternatively, it can be determined utilizing known analytical techniques.

The reaction of one or more polyisocyanates and one or more isocyanate-reactive components produces prepolymer molecules having a polyether segment that is capped with the polyisocyanate, so the molecules have terminal isocyanate groups. Each prepolymer molecule contains a polyether segment that corresponds to the structure, after removal of hydroxyl groups, of a polyol used in the prepolymer-forming reaction. If a mixture of polyols is used to make the prepolymer, a mixture of prepolymer molecules is formed.

The isocyanate-terminated prepolymer can have an isocyanate equivalent weight of from 700 to 3500, or from 700 to 3000 or from 1000 to 3000. The equivalent weight as used herein is calculated by adding the weight of the polyol(s) used to prepare the prepolymer and the weight of polyisocyanate(s) consumed in the reaction with the isocyanate-reactive component(s), and dividing by the number of moles of isocyanate groups in the resulting prepolymer. The polyisocyanate used to make the prepolymer can be any of the low equivalent weight polyisocyanate compounds mentioned herein, or a mixture of two or more of these. The prepolymer has 2 or more, or from 2 to 4, or from 2 to 3, isocyanate groups per molecule. The isocyanate groups on the prepolymer may be aromatic, aliphatic (including alicyclic), or a mixture of aromatic and aliphatic isocyanate groups. The low equivalent weight polyisocyanate compound(s) in some embodiments have an isocyanate equivalent weight of from 40 to 250, or from 50 to 200, or from 60 to 180. If a mixture of polyisocyanate compounds is present, the mixture may have, for example, an average of 2 to 4 or 2.3 to 3.5 isocyanate groups per molecule.

As stated above, the isocyanate component for forming the prepolymer includes at least one polyisocyanate, e.g., a diisocyanate. Suitable isocyanates include, for example, aromatic, cycloaliphatic, and aliphatic isocyanates. Suitable aromatic polyisocyanate compounds include, for example, m-phenylene diisocyanate, toluene-2,4-diisocyanate, toluene-2,6-di-isocyanate, naphthylene-1,5-diisocyanate, methoxyphenyl-2,4-diisocyanate, diphenyl-methane-4,4′-diisocyanate, diphenylmethane-2,4′-diisocyanate, 4,4′-bi-phenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 1,3 bis(isocyanatomethyl)benzene (xylene diisocyante XDI), 4,4′,4″-triphenyl methane triisocyanate, polymethylene polyphenylisocyanate (PMDI), toluene-2,4,6-triisocyanate and 4,4′-dimethyldiphenylmethane-2,2′,5,5′-tetraisocyanate.

Representative examples of isocyanates for use herein include the 4,4′-, 2,4′ and 2,2′-isomers of diphenylmethane diisocyante (MDI), blends thereof and polymeric and monomeric MDI blends, toluene-2,4- and 2,6-diisocyante (TDI) m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate, diphenyletherdiisocyanate, 2,4,6-triisocyanatotoluene, 2,4,4′-triisocyanatodi phenylether, ethylene diisocyanate, and 1,6-hexamethylene diisocyanate. Derivatives of any of the foregoing polyisocyanate groups that contain, e.g., biuret, urea, carbodiimide, allophonate, and/or isocyanurate groups, may be used. According to an exemplary embodiment, the isocyanate component includes MDI, e.g., 40 to 99 wt. % of the 4,4′-isomer of MDI.

Modified aromatic polyisocyanates that contain urethane, urea, biuret, carbodiimide, uretoneimine, allophonate or other groups formed by reaction of isocyanate groups are also useful. The aromatic polyisocyanate may be MDI or PMDI (or a mixture thereof that is commonly referred to as “polymeric MDI”), and so-called “liquid MDI” products that are mixtures of MDI and MDI derivatives that have biuret, carbodiimide, uretoneimine and/or allophonate linkages. All or a portion of the low equivalent weight polyisocyanate compounds may be one or more aliphatic polyisocyanates or cycloaliphatic polyisocyanates. Suitable aliphatic polyisocyanates or cycloaliphatic polyisocyanates include, for example, cyclohexane diisocyanate, 1,3- and/or 1,4-bis(isocyanatomethyl)cyclohexane, 1-methyl-cyclohexane-2,4-diisocyanate, 1-methyl-cyclohexane-2,6-diisocyanate, methylene dicyclohexane diisocyanate, isophorone diisocyanate and hexamethylene diisocyanate.

At least some of the polyisocyanate groups present in the polyisocyanate component may be aromatic isocyanate groups. If a mixture of aromatic and aliphatic isocyanate groups are present, 50% or more by number, or 75% or more by number, are aromatic isocyanate groups. In one embodiment, 80 to 98% by number of the isocyanate groups may be aromatic, and 2 to 20% by number may be aliphatic. All of the isocyanate groups of the prepolymer may be aromatic, and the isocyanate groups of the polyisocyanate compound(s) having an isocyanate equivalent weight of up to 350 may be a mixture of 80 to 95% aromatic isocyanate groups and 5 to 20% aliphatic isocyanate groups.

The one or more isocyanate-reactive components for forming the prepolymer includes one or more hydrophobic polyols selected from the group consisting of poly(butylene oxide)polyol, a polybutadiene polyol, an acrylic polyol and mixtures thereof. The hydrophobic polyol can have a functionality from 1.6 to 3.5 and a number average molecular weight from 500 g/mol to 10,000 g/mol, or from 800 g/mol to 10,000 g/mol, or from 1000 g/mol to 10,000 g/mol.

Suitable poly(butylene oxide) polyols include, for example, poly(butylene oxide) diols and poly(butylene oxide) triols. In general, the poly(butylene oxide)polyol will have a functionality from 1.6 to 3.5 or from 1.8 to 2.5 and a number average molecular weight from 500 g/mol to 5000 g/mol or from 800 g/mol to 3000 g/mol.

Suitable polybutadiene polyols include, for example, polybutadiene diols and polybutadiene triols. In general, the polybutadiene polyol will have a functionality from 1.6 to 3.5 or from 1.8 to 2.8 and a number average molecular weight from 500 g/mol to 5000 g/mol or from 800 g/mol to 3000 g/mol.

Suitable acrylic polyols include, for example, acrylic diols and acrylic triols. In general, the acrylic polyol will have a functionality from 1.6 to 3.5 or from 1.8 to 2.8 and a number average molecular weight from 500 g/mol to 10,000 g/mol or from 1000 g/mol to 10,000 g/mol.

The one or more hydrophobic polyols will be present in an amount of from 0 wt. % to 100 wt. %, or from 5 wt. % to 90 wt. %, or from 35 wt. % to 90 wt. %, or from 50 wt. % to 90 wt. %, based on the total weight of the isocyanate-reactive component. In one embodiment, the one or more hydrophobic polyols may be the majority component in the isocyanate-reactive component.

The one or more isocyanate-reactive components can further include one or more polyols in addition to the one or more hydrophobic polyols. In one embodiment, the one or more polyols includes at least one polyether polyol and/or polyester polyol. For example, polyether polyols can be the reaction product of alkylene oxides (such as at least one ethylene oxide, propylene oxide, and/or butylene oxide) with initiators containing from 2 to 8 active hydrogen atoms per molecule. Representative examples of initiators include ethylene glycol, diethylene glycol, propylene glycol, dipropylene glycol, butane diol, glycerol, trimethylolpropane, triethanolamine, pentaerythritol, sorbitol, ethylene diamine, toluene diamine, diaminodiphenylmethane, polymethylene polyphenylene polyamines, ethanolamine, diethanolamine, and mixtures thereof. Representative examples of polyols include VORANOL™ products, available from The Dow Chemical Company.

In one embodiment, suitable additional one or more polyols may include, for example, polyoxyethylene-polyoxypropylene polyether polyols having an ethylene oxide content of at least 50 wt. %, and a nominal hydroxyl functionality from 2 to 6 (e.g., 2 to 4), and a number average molecular weight from 500 g/mol to 5000 g/mol or from 500 g/mol to 4000 g/mol or from 600 g/mol to 3000 g/mol or from 600 g/mol to 2000 g/mol. The polyoxyethylene-polyoxypropylene polyether polyol having an ethylene oxide content of at least 50 wt. % may be present in an amount of from 5 wt. % to 90 wt. %, or from 10 wt. % to 90 wt. %, or from 35 wt. % to 90 wt. %, based on the total weight of the isocyanate-reactive component. In one embodiment, the polyoxyethylene-polyoxypropylene polyether polyol that has an ethylene oxide content of at least 50 wt. % is a polyoxyethylene-polyoxypropylene polyether triol. In one embodiment, the polyoxyethylene-polyoxypropylene polyether polyol that has an ethylene oxide content of at least 50 wt. % is a glycerin initiated propoxylated ethoxylated triol. In one embodiment, the polyoxyethylene-polyoxypropylene polyether polyol that has an ethylene oxide content of at least 50 wt. % may be the majority component in the isocyanate-reactive component.

In one embodiment, suitable additional one or more polyols may include, for example, polyoxypropylene-polyoxyethylene polyether polyols having an ethylene oxide content of less than 20 wt. %, a nominal hydroxyl functionality from 2 to 6 (e.g., 2 to 4) and a number average molecular weight greater than 1000 g/mol to 6000 g/mol, or from 1200 g/mol to 5000 g/mol, or from 1300 g/mol to 5000 g/mol, or from 1500 g/mol to 4000 g/mol. In one embodiment, the polyoxyethylene-polyoxypropylene polyether polyol that has an ethylene oxide content of less than 20 wt. % is a polyoxyethylene-polyoxypropylene polyether triol. In one embodiment, the polyoxyethylene-polyoxypropylene polyether polyol that has an ethylene oxide content of less than 20 wt. % is a glycerin initiated propoxylated ethoxylated triol. The polyoxypropylene-polyoxyethylene polyether polyol having an ethylene oxide content of less than 20 wt. % may be present in an amount of from 5 wt. % to 90 wt. %, or from 5 wt. % to 70 wt. %, or from 5 wt. % to 50 wt. %, or from 10 wt. % to 40 wt. %, or from 10 wt. % to 30 wt. %, based on the total weight of the isocyanate-reactive component.

In one embodiment, suitable additional one or more polyols may include, for example, polyoxypropylene polyether polyols having a nominal hydroxyl functionality from 2 to 6 (e.g., 2 to 4) and a number average molecular weight from 500 g/mol to 5000 g/mol, or from 500 g/mol to 4000 g/mol, or from 600 g/mol to 3000 g/mol, or from 600 g/mol to 2000 g/mol. The polyoxypropylene polyether polyol may be present in an amount of from 5 wt. % to 90 wt. %, or from 5 wt. % to 70 wt. %, or from 5 wt. % to 50 wt. %, or from 10 wt. to 40 wt. %, or from 10 wt. % to 30 wt. %, based on the total weight of the isocyanate-reactive component.

In one embodiment, isocyanate component (a) is prepared by combining the one or more isocyanate-reactive components with an amount of the one or more isocyanate compounds significantly greater than needed to simply cap the polyol(s) of the one or more isocyanate-reactive components. After reaction, this produces a mixture of the prepolymer and unreacted isocyanate(s). If desired, an additional amount of isocyanate(s) can then be blended into this mixture. In certain embodiments, the one or more isocyanate-reactive components are combined and reacted with an excess of one or more aromatic polyisocyanates to produce a mixture of prepolymer and unreacted starting polyisocyanate compounds. In another embodiment, this mixture is then combined with one or more aliphatic polyisocyanates.

The reaction of the one or more isocyanate compounds and one or more isocyanate-reactive components produces prepolymer molecules having a polyether segment that is capped with the polyisocyanate, so the molecules have terminal isocyanate groups. Each prepolymer molecule contains a polyether segment that corresponds to the structure, after removal of hydroxyl groups, of a polyol used in the prepolymer-forming reaction. If a mixture of polyols is used to make the prepolymer, a mixture of prepolymer molecules is formed.

In one embodiment, the prepolymer may be made in a reaction of hydrophobic polyol(s) with MDI, PMDI, a polymeric MDI, a derivative of any one or more of these that contains biuret, carbodiimide, uretoneimine and/or allophonate, or a mixture of any two or more of these, to produce a mixture of prepolymer and unreacted starting polyisocyanates, and the mixture is then combined with one or more aliphatic polyisocyanates, especially an aliphatic polyisocyanate based on hexamethylene diisocyanate.

The two-component polyurethane adhesive composition according to the present invention further includes one or more polyol chain extenders (b) to react with the isocyanate component (a). In one embodiment, suitable one or more polyol chain extenders (b) include, for example, one or more aliphatic diol chain extenders. In one embodiment, the aliphatic diol chain extender(s) can each have a hydroxyl equivalent weight of 200 or less, or 100 or less, or 75 or less or 60 or less and can have two aliphatic hydroxyl groups per molecule. In one embodiment, the aliphatic diol chain extender(s) can each have a hydroxyl equivalent weight of 20 or more, or 30 or more, or 40 or more or 50 or more and can have two aliphatic hydroxyl groups per molecule. Suitable one or more aliphatic diol chain extenders include, for example, monoethylene glycol, diethylene glycol, triethylene glycol, 1,2-propane diol, 1,3-propane diol, 2,3-dimethyl-1,3-propanediol, dipropylene glycol, tripropylene glycol, 1,4-butanediol, 1,6-hexanediol and other linear or branched alkylene diols having up to 20 carbon atoms. In one illustrative embodiment, the one or more aliphatic diol chain extenders include, for example, monoethylene glycol, 1,4-butanediol or a mixture thereof.

In general, the one or more aliphatic diol chain extenders will be present in an amount of 0.1 wt. % to 6.0 wt. %, based on the total weight of the one or more polyol chain extenders (b). In one embodiment, the one or more aliphatic diol chain extenders will be present in an amount of 0.3 wt. % to 3.0 wt. %, based on the total weight of the one or more polyol chain extenders (b).

In one embodiment, suitable one or more polyol chain extenders (b) include, for example, one or more hydrophobic polyols as discussed above, i.e., poly(butylene oxide)polyols, polybutadiene polyols, acrylic polyols and mixtures thereof. In general, the one or more hydrophobic polyol chain extenders will be present in an amount of 5 wt. % to 90 wt. %, based on the total weight of the one or more polyol chain extenders (b). In one embodiment, the one or more hydrophobic polyol chain extenders will be present in an amount of 20 wt. % to 70 wt. %, based on the total weight of the one or more polyol chain extenders (b).

In one embodiment, suitable one or more polyol chain extenders (b) include, for example, one or more polyoxypropylene-polyoxyethylene polyether polyols or polyoxypropylene polyether polyols as discussed above. In general, the one or more polyoxypropylene-polyoxyethylene polyether polyols and/or polyoxypropylene polyether polyols chain extenders will be present in an amount of 10 wt. % to 80 wt. %, based on the total weight of the one or more polyol chain extenders (b). In one embodiment, the one or more polyoxypropylene-polyoxyethylene polyether polyols and/or polyoxypropylene polyether polyols will be present in an amount of 20 wt. % to 70 wt. %, based on the total weight of the one or more polyol chain extenders (b).

The one or more isocyanate components (a) and/or one or more polyol chain extenders (b) can further include one or more latent room temperature organometallic catalysts. Any latent room temperature organometallic catalyst which provides a good open time, acceptable initial lap shear strengths and which maintain an acceptable level of reactivity after partial curing and storage may be utilized. The latent organometallic catalyst may show delayed action.

Representative classes of latent room temperature organometallic catalysts include, for example, organometallic catalysts containing tin, zinc or bismuth. In one illustrative embodiment, suitable latent room temperature organometallic catalysts include, for example, zinc alkanoates, bismuth alkanoates, dialkyltin alkanoates, dialkyl tin mercaptides, dialkyl tin bis(alkylmercaptoacetates), dialkyltin thioglycolates or mixtures thereof. In one illustrative embodiment, suitable latent room temperature organometallic catalysts include, for example, zinc neoalkanoates, bismuth neoalkanoates, dialkyltin neoalkanoates, dialkyl tin mercaptides, dialkyl tin bis(alkylmercaptoacetates), dialkyltin thioglycolates or mixtures thereof. In another illustrative embodiment, suitable latent room temperature organometallic catalysts include, for example, dialkyl tin mercaptides, dialkyl tin bis(alkylmercaptoacetates), dialkyltin thioglycolates or mixtures thereof. In one embodiment, the latent room temperature organometallic catalysts may be dialkyltin thioglycolates or mixtures thereof. The alkyl groups on the latent room temperature organometallic catalysts may be any alkyl groups of 1 or more carbon atoms or 4 or more carbon atoms. In one illustrative embodiment, the alkyl groups on the latent room temperature organometallic catalysts may be any alkyl groups of 20 or less carbon atoms or 12 or less carbon atoms. Suitable alkyl groups include, for example, methyl, butyl, octyl and dodecyl groups.

The one or more latent room temperature organometallic catalysts may be present in an amount sufficient to provide good open time, acceptable initial lap shear strengths and which maintains an acceptable level of reactivity after partial curing and storage. In one embodiment, the one or more latent room temperature organometallic catalysts may be present in an amount of from 0.0015 wt. % to 5 wt. % or from 0.01 wt. % to 1.0 wt. %. These amounts are based on active catalyst, and ignore the mass of solvents or other materials as may be present in the catalyst product.

The one or more isocyanate components (a) and/or one or more polyol chain extenders (b) can further include one or more blocked cyclic tertiary amine catalysts or one or more phenol blocked cyclic tertiary amine catalysts. Suitable blocked cyclic tertiary amine catalysts include, for example, aromatic or cycloaliphatic compounds with pending amines or aromatic or cycloaliphatic compounds with one or more nitrogen atoms incorporated into the ring structure and the like. In one embodiment, suitable one or more blocked cyclic amidine catalysts include, for example, 1,8-Diazabicyclo[5.4.0]undec-7-ene) (DBU), 1,5-Diazabicyclo[4.3.0]non-5-ene (DBN) and the like. The blocking agent may be an aliphatic carboxylic acid having 1 to 24 carbon atoms, or from 1 to 8 carbon atoms.

Suitable phenol blocked cyclic tertiary amines include, for example, phenol blocked cyclic amidine catalysts, aromatic or cycloaliphatic structures with pending amines or aromatic or cycloaliphatic structures with one or more nitrogen atoms incorporated into the ring structures and the like. In one embodiment, suitable one or more phenol blocked cyclic amidine catalysts include, for example, DBU, DBN and the like. The blocking agent may be a phenolic compound such as a phenol itself or a substituted phenol.

In one embodiment, the one or more blocked cyclic tertiary amine catalysts or one or more phenol blocked cyclic tertiary amine catalysts (iv) may be used in small amounts, such as from 0.0015 wt. % to 5 wt. % or from 0.01 wt. % to 1.0 wt. %.

The one or more isocyanate components (a) and/or one or more polyol chain extenders (b) can further include one or more particulate fillers. Suitable one or more particulate fillers include, for example, particulate fillers in the form of particles having a size of 50 nm to 100 μm. In one embodiment, the one or more particulate fillers may have a particle size (d50) of 250 nm or greater, or 500 nm or greater or 1 μm or greater. In one embodiment, the one or more particulate fillers may have a particle size (d50) of 50 μm or less, 25 μm or less or 10 μm or less. Particle sizes are conveniently measured using dynamic light scattering methods, or laser diffraction methods for particles having a size below 100 nm.

The particulate fillers are a solid material at room temperature, and not soluble in the other ingredients of the isocyanate component, chain extender or any ingredient thereof. In general, a filler is a material that does not melt, volatilize or degrade under the conditions of the curing reaction between the isocyanate component and chain extender. Suitable particulate fillers include, for example, an inorganic filler such as glass, silica, boron oxide, boron nitride, titanium oxide, titanium nitride, fly ash, calcium carbonate, various alumina-silicates including clays such as wollastonite and kaolin, metal particles such as iron, titanium, aluminum, copper, brass, and bronze; thermoset polymer particles such as polyurethane, cured particles of an epoxy, phenol-formaldehyde, or cresol-formaldehyde resin, crosslinked polystyrene and the like; thermo-plastics such as polystyrene, styrene-acrylonitrile copolymers, polyimide, polyamide-imide, polyether ketone, polyether-ether ketone, polyethyleneimine, poly(p-phenylene sulfide), polyoxymethylene, polycarbonate and the like; and various types of carbon such as activated carbon, graphite, carbon black and the like. In some embodiments, the particulate filler excludes carbon particles. The particles in some embodiments have an aspect ratio of up to 5, or up to 2, or up to 1.5.

If the one or more particulate fillers are present, they can constitute no more than 60 wt. %, based on the total weight of the two-component polyurethane adhesive composition. In one embodiment, the one or more particulate fillers may constitute 25 wt. % or greater, based on the total weight of the two-component polyurethane adhesive composition. In one embodiment, the one or more particulate fillers may constitute 60 wt. % or less or 50 wt. % or less, based on the total weight of the two-component polyurethane adhesive composition.

The one or more isocyanate components (a) and/or one or more polyol chain extenders (b) can further include one or more of the same or different dispersing aids, which wet the surface of the filler particles and help them disperse into, for example, the polyether polyol(s). The one or more dispersing aids may also have the effect of reducing viscosity. Suitable one or more dispersing aids include, for example, dispersing aids which are commercially available and sold by such sources as BYK Chemie under the BYK, DISPERBYK and ANTI-TERRA-U tradenames, such as alkylammonium salt of a low-molecular-weight polycarboxylic acid polymer and salts of unsaturated polyamine amides and low-molecular acidic polyesters, and fluorinated surfactants such as FC-4430, FC-4432 and FC-4434 from 3M Corporation. Such dispersing aids may constitute, for example, up to 2 wt. %, or up to 1 wt. %, of the two-component polyurethane adhesive composition.

The one or more isocyanate components (a) and/or one or more polyol chain extenders (b) can further include one or more desiccants such as, for example, fumed silica, hydrophobically modified fumed silica, silica gel, aerogel, various zeolites and molecular sieves, and the like. One or more desiccants may constitute 1 wt. % or greater, or 5 wt. % or less, or 4 wt. % or less, based on the total weight of the two-component polyurethane adhesive composition. In one embodiment, the two-component polyurethane adhesive composition does not include a desiccant.

The one or more isocyanate components (a) and/or one or more polyol chain extenders (b) can further include one or more plasticizers. Suitable plasticizers include, for example, a phthalate, terephthalate, mellitate, sebacate, maleate or other ester plasticizer, a sulfonamide plasticizer, a phosphate ester plasticizer, or a polyether di(carboxylate) plasticizer. The plasticizer may be present in an amount of 1 wt. % to 25 wt. %, or from 10 wt. to 25 wt. %, or from 15 wt. % to 20 wt. %, based on the total weight of the two-component polyurethane adhesive composition. In one embodiment, the two-component polyurethane adhesive composition does not include a plasticizer.

The one or more isocyanate components (a) and/or one or more polyol chain extenders (b) can further include one or more curative components. Suitable one or more curative components include, for example, at least one amine based curing agent. For example, the amine based curing agent may be a bifunctional organic diamine compound, such as a toluene based diamine, a phenyl based diamine, an alkyl based dianiline, a polyether based diamine, or an isophorone based diamine, or a trifunctional organic diamine compound, such as a phenyl based triamine, an alkyl based tramine, or a propylene based triamine. The one or more curative components may be present in an amount of 5 wt. % to 50 wt. % or from 10 wt. % to 45 wt. %, or from 15 wt. % to 40 wt. %, or from 20 wt. % to 35 wt. % based on the total weight of the two-component polyurethane adhesive composition.

The one or more isocyanate components (a) and/or one or more polyol chain extenders (b) are formulated such that the isocyanate index is 0.5 to 2.0, or 0.9 to 1.9, or 0.9 to 1.8, or 1 to 1.8. “Isocyanate index” is the ratio of the number of isocyanate groups in the isocyanate component to the number of isocyanate-reactive groups in the polyol components.

The two-component polyurethane adhesive composition is formed by mixing the one or more isocyanate components (a) and one or more polyol chain extenders (b) and optional components. The mixing and application can be done in any convenient manner. For example, the one or more isocyanate components (a) and one or more polyol chain extenders (b) can be simply combined at ambient temperature or any desirable elevated temperature, deposited onto the substrate, and allowed to react. The mixing of the components can be done in any convenient way, depending on the particular application and available equipment. Mixing of the components can be done batchwise, mixing them by hand or by using various kinds of batch mixing devices, followed by application by brushing, pouring, applying a bead and/or in other suitable manner. In one embodiment, the isocyanate component (a) and one or more polyol chain extenders (b) can be packaged into separate cartridges and simultaneously dispensed through a static mixing device to mix and apply them, typically as a bead, onto the interface of the substrate.

In one embodiment, the two-component polyurethane adhesive composition according to the present invention can be obtained by a process including at least the steps of (a) metering a first stream comprising the one or more isocyanate components (a) into an in-line mixing unit, and (b) metering a second stream comprising the one or more polyol chain extenders (b) into the in-line mixing unit, wherein the one or more isocyanate components (a) and one or more polyol chain extenders (b) are contacted in the in-line mixing unit to form the two-component polyurethane adhesive composition; and (d) dispensing the two-component polyurethane adhesive composition. The in-line mixing unit can be, for example, a static mixing unit or a dynamic mixing unit.

The one or more isocyanate components (a) and one or more polyol chain extenders (b) are metered into the in-line mixing unit in a volume weight ratio of the one or more isocyanate components (a) to the one or more polyol chain extenders (b) of 0.7:1.3 to 1.3:0.7. In one embodiment, the one or more isocyanate components (a) and one or more polyol chain extenders (b) are metered into the in-line mixing unit in a volume weight ratio of the one or more isocyanate components (a) to the one or more polyol chain extenders (b) of 0.8:1.2 to 1.2:0.8.

The one or more isocyanate components (a) and one or more polyol chain extenders (b) are advantageously contacted in the in-line mixing unit in any order and amount taking into consideration the volume ratio discussed above. For example, the one or more isocyanate components (a) can first be metered into the in-line mixing unit, followed by the one or more polyol chain extenders (b). In one embodiment, a first amount of the one or more polyol chain extenders (b) can be metered into the in-line mixing unit, followed by the one or more isocyanate components (a). In one embodiment, the first polyol component, second polyol component and isocyanate component are advantageously contacted in the in-line mixing unit for a time of 2 min, e.g., from 60 min to less than 1 min.

Once the one or more isocyanate components (a) and one or more polyol chain extenders (b) are contacted in, for example, the in-line mixing unit, to form the two-component polyurethane adhesive composition, the two-component polyurethane adhesive composition can then be dispensed. In one embodiment, a process for bonding two substrates is provided which includes applying the two-component polyurethane adhesive composition to at least a portion of a first substrate; and contacting a second substrate with the first substrate with the two-component polyurethane adhesive composition being disposed between the first and second substrate. The mixed adhesive composition is formed into an adhesive layer between and in contact with the two substrates. If desired, an adhesion promoter may be applied to one or both of the substrates prior to contacting the substrate(s) with the two-component polyurethane adhesive composition. The adhesive layer is then cured between and in contact with the two substrates to form a layer of cured adhesive bonded to each of the two substrates.

The one or more isocyanate components (a) and one or more polyol chain extenders (b) often will react spontaneously upon mixing at room temperature (22° C.) and cure without the need to heat the adhesive to a greater temperature. Curing may be effected by simply mixing the components at a temperature of, for example, 0 to 35° C. and allowing the components to react at that temperature. At approximately room temperature, the two-component polyurethane adhesive composition may exhibit an open time of 2 minutes or greater, or 3 minutes or greater, or 4 minutes or greater, or 10 minutes or greater, measured as described in the examples. In one embodiment, the three-component polyurethane adhesive composition may exhibit an open time of no more than 10 minutes at approximately room temperature. Often, the adhesive will fully cure without exposing it to elevated temperature, infrared radiation or other energy source, due at least in part to the catalytic action of the latent room temperature organometallic catalysts, e.g., dialkyltinthioglycolate catalyst. In addition, it is believed that the acid-blocked cyclic amidine catalyst or phenol-blocked cyclic amidine compounds catalyst de-blocks during the infrared heating stage, to produce an active catalyst that also promotes the cure during the subsequent curing step, even if that subsequent step is performed without additional applied energy.

If necessary or desired, heating can be applied to the adhesive to obtain a more rapid cure. In general, the one or more isocyanate components (a) and one or more polyol chain extenders (b) may be mixed at a lower temperature, such as 0 to 35° C. and then heated to a higher cure temperature. The substrate can be heated before applying the adhesive if desired. If an elevated temperature is used in the curing step, such a temperature may be, for example, 36° C. or greater, or 50° C. or greater. Such a temperature may be, for example, 150° C. or less, or 140° C. or less.

The methods disclosed may further comprise any one or more of the features described in this specification in any combination, including the preferences and examples listed in this specification, and can include the following features: the step of heating one or both of the two substrates at a temperature for a time to procure or fully cure the mixture so as to bond the two substrates together. The heat can be applied, for example, by infrared heating, oven cure or any other heat source that is capable to heat the adhesive. In one embodiment, one or both of the two substrates can be heated right after application of the adhesive composition to the substrate. In another embodiment, the time frame between the step of applying the adhesive composition to the substrate and the step of heating may be 1 hour or more, or 24 hours or more.

In general, a layer of the two-component polyurethane adhesive composition is formed at a bondline between two substrates to form an assembly. The adhesive layer is then at least partially cured at the bondline by applying, for example, infrared radiation to the assembly or any other conventional heat source known to one skilled in the art. Infrared radiation may be applied, for example, until the temperature of the adhesive layer reaches 50° C. or greater, or 80° C. or greater, or 150° C. or less, or 130° C. or less. The assembly so heated may be maintained under infrared radiation until the adhesive layer has been exposed to such temperatures for a period of 5 seconds or more to affect the partial or complete cure. For example, the infrared radiation may be continued until the temperature of adhesive layer is 80° C. to 150° C., or for 90° C. to 130° C., at which time the exposure to infrared radiation may be discontinued. In one embodiment, the infrared radiation may be continued for a time period of 5 to 600 seconds, or from 10 to 300 seconds, or from 30 to 200 seconds, at which time the exposure to infrared radiation is discontinued.

The substrates are not limited. Suitable substrates include, for example, a metal, a coated metal, a metal alloy, an organic polymer, a lignocellulosic material such as wood, cardboard or paper, a ceramic material, various types of composites, plastics, reinforced plastics, glass or other materials. When used with a low surface energy plastic, the surface of the low surface energy plastic can be surface treated prior to application of the composition of the invention. Any known surface treatment means which increases the number of polar groups present on the surface of the plastic may be utilized, including flame treatment, corona discharge, chemical etching and the like. In one embodiment, the substrate is a flame treated polypropylene substrate.

Further handing may include, for example, transporting the assembly to a downstream work station, and further manufacturing steps which might include joining the assembly to one or more other components, various shaping and/or machining steps, the application of a coating, and the like. The completion of the cure can take place during and/or after such additional handling steps.

Molecular weights as described herein are number average molecular weights which may be determined by Gel Permeation Chromatography (also referred to as GPC).

The following examples are provided to illustrate the disclosed compositions, but are not intended to limit the scope thereof. All parts and percentages are by weight unless otherwise indicated.

The following designations, symbols, terms and abbreviations are used in the Examples below:

Isonate M143 is a modified liquid MDI product having an isocyanate functionality of about 2.2, a molecular weight of 319 g/mol and a viscosity of 40 mPas viscosity, available from the DOW Chemical Company.

TAKENATE™ 500 is an aliphatic diisocyanate 1,3 bis(isocyanatomethyl)benzene (xylene diisocyante XDI) with a molecular weight of 188 g/mol and an isocyanate content of approx. 11.2%, available from Mitsui Chemicals, Inc.

Isonate O,P 50 is an asymmetric ortho, para methylene diphenyl diisocyante with equivalent weight of 125.5 g/mol and an isocyanate content of 33.5% available from the DOW Chemical Company.

Fomrez UL29 is a dioctyltinmercaptide catalyst, available from Momentive.

1,8-diazabicyclo-5.4.0-undecene-7 (DBU) carboxylic acid blocked amine catalyst, available from TOSOH as TOYOCAT DB60 (phthalic acid blocked DBU salt).

POLYCAT SA 1/10 is a carboxylic acid blocked DBU salt, available from Air Products.

Voranol 4000L is a polypropylene homopolymer with an average equivalent molecular weight of 2000 g/mol molecular weight and a OH number of approx. 26.5 to 29.5 mg KOH/g, available from the DOW Chemical Company.

Voranol CP4711 is a glycerin initiated propoxylated and ethoxylated based triol with an average equivalent molecular weight of 1603 g/mol and an OH number of approx. 35 mg KOH/g, available from the DOW Chemical Company.

Voranol CP6001 is a glycerin initiated propoxylated and ethylenoxide end-capped triol with an average equivalent molecular weight of 2000 g/mol molecular weight and an OH number of approx. 35 mg KOH/g, available from the DOW Chemical Company.

Krasol LBH 2000 is a hydrophobic polyol based on a liquid hydroxyl terminated polymer of butadiene with a molecular weight of 2100 g/mol and a polydispersity of 1.3 and a hydroxyl value of 0.91 mq/g, available from Cray Valley. Krasol LBH 2000 contains 65% 1,2 vinyl, 12.5% 1,4 cis and 22.5 1,4 trans double bonds.

Vorapel™ D3201 is a hydrophobic polyol based on a hydrophobically modified (polybutyleneoxide)diol with an average molecular weight of 1921 g/mol to 2125 g/mol and an OH number of approx. 56 mg KOH/g, available from the DOW chemical Company.

Vorapel™ 4500 is a hydrophobic polyol based on a hydrophobically modified (polybutyleneoxide)triol with an average molecular weight of 1500 g/mol, available from the DOW chemical Company.

Modarez MF AOH is a hydrophobic polyol based on a hydroxyl functionalized acrylic polymer, available from Synthron.

1,4 butandiol chain extender.

KaMin™ 100C (IMERYS) is pre-dried calcined China clay (55% SiO₂, 45% Al₂O₃) with an average particle size of approx. 2 □m (90%>10 □m), a BET surface of 8.5 m²/g and a pH of 6.0 to 6.5.

Aerosil® R 202 is hydrophobically modified polydimethylsiloxane coated fumed silica, available from Evonik Industries.

Molecular sieves of the type 4A.

BETASEAL™ 1K is a partially silanated, high modulus polyurethane adhesive, available from The Dow Chemical Co. See, e.g., U.S. Pat. No. 8,236,891.

Testing and Analytical Procedures

The Young's modulus, tensile strength and elongation at break of the cured adhesive (23° C.±2° C. at 50%±5% Relative Humidity) compositions were determined as per ASTM D638.

Substrates: Different polypropylene (PP) grades were used for peel adhesion tests. One grade was the unfilled polypropylene Sabic® 579S. Another grade was Sabic® Stamax 40YM23 which is a 40% long glass fiber filled polypropylene. The glass fibers are chemically coupled to the polypropylene matrix, resulting in high strength and stiffness.

Substrate Preparation. A dried PP surface was exposed to a flame treatment using standard DOW Automotive Europe conditions: Flame treatments were performed on a ARCOGAS FTS 101D instrument from ARCOTEC, Oberflachentechnik GmbH, using an air-propane mixture 50:2 without further oxygen addition, a distance of 100 mm between flame and substrate and a substrate velocity of 600 mm/s. Testing for polyolefin bonding was done on molded PP. The evaluation of the bonding results were done on the basis of the peel adhesion.

Peel strength. Performance of the examples were evaluated with a peel adhesion test to flame treated polypropylene grades Sabic® Stamax 40YM23 and Sabic® 579S.

Peel Adhesion Test. In the peel adhesion test, the adhesive was applied onto the flame-treated PP substrate, typically with a bead dimension of 10 mm (height)×10-15 mm (width)×200 mm (length). The adhesive (L1) was compressed to a height of approx. 6 mm After the exposure as described hereinafter the following test is performed. The adhesive bead is cut on the edge approximately 10 mm parallel to the substrate and peeled off in a 90 degree angle. At approximately each 10 mm, the peeled off bead is cut with a knife to the substrate and peeling is continued. The peeled samples are evaluated according to the percentage of cohesive failure (CF), meaning failure within the hardened bulk of the adhesive. As used herein with the failure mode percentages the designation AF means the adhesive with or without primer exhibits delaminating from the substrate. Sample storage at elevated temperatures was performed in ventilated ovens.

Exposure Cycle. The exposure cycle for the performed screening was (1) 7 days at 23° C. at 50% relative humidity (rh), and (2) plus 7 days of cataplasm. Cataplasma treatment is the surrounding of the sample with cotton and saturating the cotton packaging with water, wrapping the wet cotton wrapped sample in aluminum foil and PE foil to avoid evaporation. The packed sample is exposed for 7 days at 70° C., then 16 h at −20° C., then brought to ambient temperature (23° C.) and the unwrapped sample is stored for 2 hours at 23° C.

The hydrophobic content of the polyurethane adhesive compositions listed in Tables 3 and 4 below was determined by adding the respective weight amounts of the hydrophobic polyols in the isocyanate component and the polyol component and diving the total calculated weight percent of the hydrophobic polyols by two, based on a 1:1 mixing ratio of the isocyanate component and the polyol component.

Isocyanate Component Preparation Process

The following ingredients and amounts for the isocyanate component designated as “ISO 1” through “ISO 10” are set forth below in Table 1. All amounts listed are in weight percent.

TABLE 1

| | ISO 1 | ISO 2 | ISO 3 | ISO 4 | ISO 5 | ISO 6 | ISO 7 | ISO 8 | ISO 9 | ISO 10 |
|---|---|---|---|---|---|---|---|---|---|---|
| Isonate M 143 | 16.00 | — | — | 14.80 | 14.20 | 16.00 | — | — | — | — |
| Isonate OP 50 | — | — | — | — | — | — | 13.95 | 12.33 | 16.00 | 16.00 |
| TAKENATE 500 | — | 11.50 | 11.25 | — | — | — | — | — | — | — |
| Voranol CP 4711 | 30.00 | 35.00 | 37.00 | 35.00 | — | — | 33.00 | — | — | — |
| Vorapel D3201 | 20.00 | 25.00 | — | — | — | 25.00 | 23.00 | 17.00 | 22.00 | 57.00 |
| MODAREZ OH | — | — | — | — | — | — | — | 40.00 | — | — |
| Krasol 2000LBH | — | — | 26.00 | — | — | — | — | — | 35.00 | — |
| Voranol 4000 LM | — | — | — | 25.00 | 25.00 | — | — | — | — | — |
| Voranol CP 6001 | — | — | — | — | 35.0 | 35.00 | — | — | — | — |
| KaMin 100C | 33.00 | 27.50 | 24.75 | 24.20 | 24.80 | 23.00 | 29.05 | 29.67 | 26.00 | 25.50 |
| Aerosil R 202 | 1.00 | 1.00 | 1.00 | 1.00 | 1.00 | 1.00 | 1.00 | 1.00 | 1.00 | 1.00 |

The isocyanate component in Table 1 was prepared as follows. A mixing vessel of 5 Liters was prepared with the stated amounts of respective isocyanates and OH-terminated polyol. The mixture was stirred for 5 minutes until a homogenous liquid phase was obtained under normal conditions. Then the stated amounts of KaMin 100C, and Aerosil R 208 were added, and mixing was started carefully at a low speed of 35 rpm. As soon as the filler started to moisten the speed was increased. The mixture was then heated to 75° C. under vacuum for 60 minutes. After 1 hour of mixing time, the temperature was decreased 23° C. from the mixing temperature, the mixing speed was stopped and the material was filled into cartridges.

The following ingredients and amounts for the polyol component designated as “Pol 1” and “Pol 2” are set forth below in Table 2. All amounts listed are in weight percent.

TABLE 2

| | POL 1 | POL 2 |
|---|---|---|
| Voranol CP 4711 | 53.00 | — |
| butandiol | 0.50 | 0.40 |
| Vorapel 4500 triol | — | 53.50 |
| Kamin 100C | 40.39 | 40.49 |
| Aerosil R 202 | 1.50 | 1.50 |
| POLYCAT SA 1/10 | 0.02 | 0.02 |
| UL-29 | 0.04 | 0.04 |
| TOYOCAT DB 60 | 0.05 | 0.05 |
| molecular sieve 4A | 4.00 | 4.00 |

The polyol component in Table 2 was prepared as follows. A mixing vessel of 5 Liters was prepared with the stated amounts of respective polyols and catalysts. The mixture was stirred for 2 to 3 minutes until a homogenous liquid phase was obtained. Then the stated amounts of KaMin 100C, and Aerosil R 208 were added while mixing at a speed of 50 rpm under vacuum for 40 to 50 minutes at 23° C. After 1 hour mixing time, the polyol component was filled into cartridges.

### Comparative Examples A-H

The polyurethane adhesive compositions of Comparative Examples A-H are prepared by blending the formulations (i.e., components (a) and (b)) listed in Tables 1 and 2 in a volumetric mixing ratio of 1:1, using a 2 component air pressured application gun with amounted static mixer. The formulations together with their physical properties and the adhesion performance are set forth below in Table 3. Comparative Example A is a BETA-SEAL™ 1K polyurethane adhesive composition.

TABLE 3

| | Comp. | Comp. | Comp. | Comp. | Comp. | Comp. | Comp. | Comp. |
|---|---|---|---|---|---|---|---|---|
| | Ex. A | Ex. B | Ex. C | Ex. D | Ex. E | Ex. F | Ex. G | Ex. H |
| Comp, (a) | | ISO 4 | ISO 5 | ISO 6 | ISO 3 | ISO 7 | ISO 9 | ISO 2 |
| Comp, (b) | | POL 1 | POL 1 | POL 1 | POL 1 | POL 1 | POL 1 | POL 1 |
| Hydrophobic | — | — | — | 12.50 | 13.00 | 11.50 | 28.50 | 12.50 |
| Content | | | | | | | | |
| Properties | | | | | | | | |
| Young's modulus, | 4.5 | 6.0 | 4.3 | 4.5 | 3.8 | 2.4 | 3.0 | 2.8 |
| [MPa] | | | | | | | | |
| Tensile strength, | 6.0 | 6.3 | 6.3 | 5.8 | 5.9 | 5.3 | 4.6 | 5.0 |
| [MPa] | | | | | | | | |
| Elongation | 230 | 158 | 199 | 209 | 262 | 433 | 354 | 266 |
| at break [%] | | | | | | | | |
| Cohesive failure, | 50CF/ | 5CF/ | 5CF/ | 5CF/ | 38CF/ | 98CF/ | 56CF/ | 28CF/ |
| peel adhesion PP, | 50AF¹ | 95AF | 95AF | 95AF | 62AF | 2AF | 44AF | 72AF |
| 3 d RT [%] | | | | | | | | |
| Cohesive failure, | 50CF/ | 5CF/ | 5CF/ | 5CF/ | 5CF/ | 28CF/ | 31CF/ | 28CF/ |
| peel adhesion PP, | 50AF¹ | 95AF | 95AF | 95AF | 95AF | 72AF | 69AF | 72AF |
| 7 d RT [%] | | | | | | | | |

¹slow curing 1K polyurethane in combination with MDI solvent based primer.

### Examples 1-6

The polyurethane adhesive compositions of Examples 1-6 are prepared by blending the formulations (i.e., components (a) and (b)) listed in Tables 1 and 2 in a volumetric mixing ratio of 1:1, using a 2 component air pressured application gun with amounted static mixer. The formulations together with their physical properties and the adhesion performance are set forth below in Table 4.

TABLE 4

| | Ex. 1 | Ex. 2 | Ex. 3 | Ex. 4 | Ex. 5 | Ex. 6 |
|---|---|---|---|---|---|---|
| Comp, (a) | ISO 1 | ISO 1 | ISO 2 | ISO 3 | ISO 8 | ISO 10 |
| Comp, (b) | POL 1 | POL 2 | POL 2 | POL 2 | POL 1 | POL 1 |
| Hydrophobic | 10.00 | 26.75 | 39.25 | 39.75 | 28.50 | 28.50 |
| Content | | | | | | |
| Properties | | | | | | |
| Young's modulus, | 7.3 | 10.7 | 3.8 | 4.8 | 2.4 | 2.3 |
| [MPa] | | | | | | |
| Tensile strength, | 6.0 | 6.2 | 5.1 | 6.1 | 4.0 | 4.3 |
| [MPa], (STDEV) | | | | | | |
| Elongation at | 207 | 170 | 217 | 223 | 222 | 385 |
| break, [%] | | | | | | |
| Cohesive failure, | 45CF/ | 50CF/ | 53CF/ | 50CF/ | 100CF | 100CF |
| peel adhesion PP, | 55AF | 50AF | 47AF | 50AF | | |
| 3 d RT [%] | | | | | | |
| Cohesive failure, | 88CF/ | 76CF/ | 67CF/ | 85CF/ | 100CF | 50CF/ |
| peel adhesion PP, | 12AF | 27AF | 33AF | 15AF | | 50CF |
| 7 d RT [%] | | | | | | |

The data from Tables 3 and 4 show that the polyurethane adhesive compositions within the scope of the present invention had a more a durable bond when subjected into the cataplasm test than the polyurethane adhesive compositions outside the scope of the present invention.

What is claimed is:

1. A two-component polyurethane adhesive composition comprising:
(a) an isocyanate component comprising a prepolymer which is a reaction product of one or more isocyanate compounds comprising a polyisocyanate and one or more isocyanate-reactive components comprising one or more hydrophobic polyols selected from the group consisting of a poly(butylene oxide)polyol, a polybutadiene polyol, an acrylic polyol and mixtures thereof, wherein the one or more hydrophobic polyols have a functionality from 1.6 to 3.5 and a number average molecular weight from 500 g/mol to 10,000 g/mol; and
(b) one or more polyol chain extenders;
wherein the two-component polyurethane adhesive composition has a hydrophobic content of at least 10 wt. %.

2. The two-component polyurethane adhesive composition according to claim 1, wherein the prepolymer has a free isocyanate content of from 1 wt. % to 20 wt. % of the prepolymer.

3. The two-component polyurethane adhesive composition according to claim 1, wherein the polyisocyanate is a monomeric diphenylmethane diisocyanate, polycarbodiimide-modified diphenylmethane diisocyanate, a polymeric diphenylmethane diisocyanate, a xylene diisocyanate or a combination thereof.

4. The two-component polyurethane adhesive composition according to claim 1, wherein the one or more hydrophobic polyols comprise a poly(butylene oxide)polyol having a number average molecular weight from 1.6 to 3.5.

5. The two-component polyurethane adhesive composition according to claim 1, wherein the one or more hydrophobic polyols comprise a poly(butylene oxide)polyol having a number average molecular weight from 800 g/mol to 3000 g/mol and an acrylic polyol having a number average molecular weight from 1000 g/mol to 10,000 g/mol.

6. The two-component polyurethane adhesive composition according to claim 1, wherein the one or more isocyanate-reactive components further comprise one or more polyoxypropylene-polyoxyethylene polyether polyols having an ethylene oxide content of less than 20 wt. %, a nominal hydroxyl functionality from 2 to 6 and a number average molecular weight greater than 1000 g/mol to 6000 g/mol.

7. The two-component polyurethane adhesive composition according to claim 1, wherein the one or more isocyanate-reactive components comprise a poly(butylene oxide)polyol having a number average molecular weight from 800 g/mol to 3000 g/mol and a polyoxypropylene-polyoxyethylene polyether polyol having an ethylene oxide content of less than 20 wt. %, a nominal hydroxyl functionality from 2 to 6 and a number average molecular weight greater than 1000 g/mol to 6000 g/mol.

8. The two-component polyurethane adhesive composition according to claim 1, wherein the one or more isocyanate-reactive components comprise an acrylic polyol having a number average molecular weight from 1000 g/mol to 10,000 g/mol and a polyoxypropylene-polyoxyethylene polyether polyol having an ethylene oxide content of less than 20 wt. %, a nominal hydroxyl functionality from 2 to 6 and a number average molecular weight greater than 1000 g/mol to 6000 g/mol.

9. The two-component polyurethane adhesive composition according to claim 1, wherein the one or more polyol chain extenders comprise an aliphatic diol.

10. The two-component polyurethane adhesive composition according to claim 9, wherein the aliphatic diol have a hydroxyl equivalent weight of 200 or less and two aliphatic hydroxyl groups per molecule.

11. The two-component polyurethane adhesive composition according to claim 9, wherein the one or more polyol chain extenders further comprise one or more of a poly(butylene oxide)polyol having a number average molecular weight from 800 g/mol to 3000 g/mol, polybutadiene polyol having a number average molecular weight from 800 g/mol to 3000 g/mol and a polyoxypropylene-polyoxyethylene polyether polyol having an ethylene oxide content of less than 20 wt. %, a nominal hydroxyl functionality from 2 to 6 and a number average molecular weight greater than 1000 g/mol to 6000 g/mol.

12. The two-component polyurethane adhesive composition according to claim 1, wherein the isocyanate component (a) and one or more polyol chain extenders (b) further comprise one or more latent room temperature organometallic catalysts, one or more particulate fillers, one or more plasticizers and combinations thereof.

13. The two-component polyurethane adhesive composition according to claim 1, having a hydrophobic content of from 10 to 80.

14. A method comprising
(a) applying a two-component polyurethane adhesive composition to at least a portion of a first substrate, wherein the two-component polyurethane adhesive composition comprises:
(i) an isocyanate component comprising a prepolymer which is a reaction product of one or more isocyanate compounds comprising a polyisocyanate and one or more isocyanate-reactive components comprising one or more hydrophobic polyols selected from the group consisting of a poly(butylene oxide)polyol, a polybutadiene polyol, an acrylic polyol and mixtures thereof, wherein the one or more hydrophobic polyols have a functionality from 1.6 to 3.5 and a number average molecular weight from 500 g/mol to 10,000 g/mol; and
(ii) one or more polyol chain extenders;
wherein the two-component polyurethane adhesive composition has a hydrophobic content of at least 10 weight %,
(b) contacting a second substrate with the first substrate; and
(c) curing the two-component polyurethane adhesive composition to form an adhesive bond between the first and second substrates.

15. The method according to claim 14, wherein the one or more isocyanate-reactive components comprise a poly(butylene oxide)polyol having a number average molecular weight from 800 to 3000 and a polyoxypropylene-polyoxyethylene polyether polyol having an ethylene oxide content of less than 20 wt. %, a nominal hydroxyl functionality from 2 to 6 and a number average molecular weight greater than 1000 g/mol to 6000 g/mol.

16. The method according to claim 14, wherein the one or more isocyanate-reactive components comprise an acrylic polyol having a number average molecular weight from 1000 g/mol to 10,000 g/mol and a polyoxypropylene-polyoxyethylene polyether polyol having an ethylene oxide content of less than 20 wt. %, a nominal hydroxyl functionality from 2 to 6 and a number average molecular weight greater than 1000 g/mol to 6000 g/mol.

17. The method according to claim 14, wherein the one or more polyol chain extenders comprise an aliphatic diol.

18. The method according to claim 17, wherein the one or more polyol chain extenders further comprise one or more of a poly(butylene oxide)polyol having a number average molecular weight from 800 to 3000, polybutadiene polyol having a number average molecular weight from 800 to 3000 and a polyoxypropylene-polyoxyethylene polyether polyol having an ethylene oxide content of less than 20 wt. %, a nominal hydroxyl functionality from 2 to 6 and a number average molecular weight greater than 1000 g/mol to 6000 g/mol.

19. The method according to claim 14, wherein the first and the second substrate are polypropylene substrates.

20. The method according to claim 19, wherein the polypropylene substrates are flame treated polypropylene substrates.
